(19) United States
(12) Patent Application Publication
(10) Pub. No.: US 2009/0312566 A1
(43) Pub. Date: Dec. 17, 2009

(54) Multiply substituted ferrocenes

(76) Inventors: Benoît Pugin, Munchenstein (CH); Xiangdong Feng, Qingdao (CN)

Correspondence Address: WENDEROTH, LIND & PONACK, L.L.P., 1030 15th Street, N.W.,, Suite 400 East, Washington, DC, 20005-1503, US

(21) Appl. No.: 11/919,396

(22) PCT Filed: Apr. 27, 2006
(86) PCT No.: PCT/EP2006/061861

§ 371 Date: Oct. 26, 2007

(30) Foreign Application Priority Data
Apr. 28, 2005 (CH) 0748/05

(51) Int. Cl. C07F 17/02

(52) U.S. Cl. 556/11; 556/144; 556/22

(57) ABSTRACT

Disclosed are compounds of formulas (I) and (II) in the form of enantiomer-pure diastereomers or diastereomer mixtures. In said formulas (I) and (II), R′₁, represents C₁-C₄ alkyl while n represents 0 or an integer from 1 to 5; R₁ represents a hydrogen atom, a hydrocarbon radical with 1 to 20 C atoms, secondary phosphino, a mercaptan radical with 1 to 20 C atoms in the hydrocarbon radical, or a silyl radical with 3 C₁-C₁₂ hydrocarbon radicals; R₂ is the monovalent radical of an electrophilic organic compound; X₁ represents F, Cl, Br, or I; and Y represents vinyl, methyl, ethyl, —CH₂—N(C₁-C₄-alkyl)₂, —CH₂—OR wherein R is a hydrocarbon radical, or a C-bonded, S-bonded, or P-bonded chiral group that directs metals of metallization reagents into the ortho position X₁. The inventive compounds are coordinating ligands for metal complexes of transition metals as homogeneous catalysts for coupling reactions and intermediate products for producing bidentate ligands.

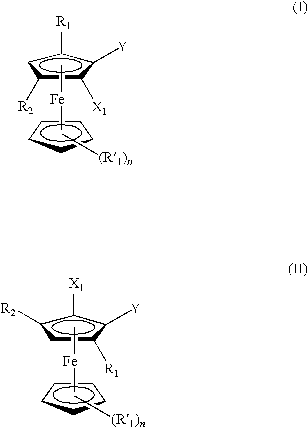

The present invention relates to monohalogenated ferrocenes having at least 2 further substituents in one cyclopentadienyl ring, and a process for preparing them.

Coordinating or monodentate ligands are of importance for metal complexes of transition metals, for example the TM-8 metals of the periodic table of the elements, which are frequently used as catalysts in coupling reactions in organic chemistry. The ligands enable the activity and selectivity of a catalyst to be influenced, with the number and type of substituents and their position relative to the coordinating group playing an important role. There is therefore great interest in substituted and coordinating ligands by means of which the properties of a catalyst system can be influenced and optimized to chosen substrates. Furthermore, there is a particular need for chiral ligands for stereoselective, catalytic reactions, as can be realized, for example, using the ferrocene skeleton.

Ferrocenes have proven to be a valuable basic skeleton for monodentate ligands, but ferrocenes which are multiply substituted in one cyclopentadienyl ring can be obtained only with difficulty. For example, in Journal of the Chemical Society, Chemical Communications Volume 23 (1974), pages 967-968, D. W. Slocum et al. describe a lithiation of 1-methyl-2-chloroferrocene by means of butyllithium in the ortho position relative to the chlorine atom and the further reaction with benzophenone or methyl iodide to form 1,2,3-substituted ferrocenes. In Inorganic Chemistry Communications 1999, 2(9), pages 424-427, I. R. Butler et al. describe a lithiation in the ortho position relative to the bromine atom in 1,1′-dibromoferrocene using a lithium amide. However, these two overall reactions are not stereoselective. In Tetrahedron: Asymmetry 2004, 15(24) pages 3835-3840, N. D'Antona et al. describe the lithiation of 1-[(1-dimethylamino)eth-1-yl]ferrocene by means of butyllithium in the ortho position, subsequent introduction of a t-butylthio group and its stereoselective oxidation to the sulfoxide. Only the chiral sulfoxide allows renewed stereoselective lithiation in the ortho position relative to the sulfoxide group and subsequent reaction with methyl iodide leads to a 1,2,3-substituted ferrocene.

It has surprisingly been found that ferrocenes having a total of 3 or 4 substituents in one cyclopentadienyl ring can be prepared stereoselectively in a simple way.

For this purpose, ferrocenes which in one cyclopentadienyl ring have a chiral substituent which allows stereoselective metallation in the ortho position in a manner known per se are used as starting materials. In this way, diastereomers are obtained directly in high optical yields in the synthesis, so that complicated separation operations are avoidable. The metal in ferrocenes which have been metallated in this way can then be replaced by halogen in a manner which is likewise known per se.

It has now surprisingly been found that such halogenated ferrocenes can be metallated again under mild conditions and even stereoselectively by means of metal bases. Subsequent reaction with electrophilic organic compounds leads to multiply substituted compounds which can even be modified further, for example by introduction of a coordinating group if none is present.

The invention firstly provides compounds of the formulae I and II in the form of enantiomerically pure diastereomers or a mixture of diastereomers,

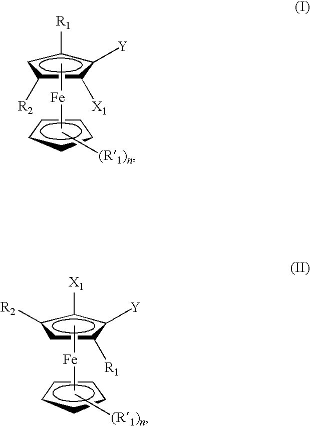

where
R′₁ is C₁-C₄-alkyl or phenyl and n is 0 or an integer from 1 to 5;
R₁ is a hydrogen atom, a hydrocarbon radical having from 1 to 20 carbon atoms, sec-phosphino, a mercaptan radical having from 1 to 20 carbon atoms in the hydrocarbon radical or a silyl radical having 3 C₁-C₁₂-hydrocarbon radicals;
R₂ is the monovalent radical of an electrophilic organic compound;

### X₁ is F, Cl, Br or I;

Y is vinyl, methyl, ethyl; —CH₂—OR, —CH₂—N(C₁-C₄-alkyl)₂ or a C-, S- or P-bonded chiral group which directs metals of metallating reagents into the ortho position X₁; and
R is an aliphatic, cycloaliphatic, aromatic or aromatic-aliphatic hydrocarbon radical which has from 1 to 18 carbon atoms and is unsubstituted or substituted by C₁-C₄-alkyl, C₁-C₄-alkoxy, F or CF₃.

A hydrocarbon radical R can be, for example, alkyl, cycloalkyl, heterocycloalkyl, cycloalkylalkyl, heterocycloalkylalkyl, aryl, aralkyl, heteroaryl, heteroaralkyl having heteroatoms selected from the group consisting of O, S, —N═ and —N(C₁-C₄-alkyl), where cyclic radicals preferably contain from 5 to 7 ring atoms, alkyl preferably contains from 1 to 6 carbon atoms and “alkyl” in cyclic radicals preferably contains 1 or 2 carbon atoms. Some examples of R are methyl, ethyl, n-propyl, n-butyl, cyclohexyl, cyclohexylmethyl, tetrahydrofuryl, phenyl, benzyl, furanyl and furanylmethyl.

X₁ is particularly preferably Br.

An alkyl group. R′₁ can be, for example, methyl, ethyl, n- or i-propyl, n-, i- or t-butyl, with preference being given to methyl. n is preferably 0 (and R′₁ is thus a hydrogen atom).

A hydrocarbon radical R₁ preferably contains from 1 to 12, more preferably from 1 to 8 and particularly preferably from 1 to 4, carbon atoms. The hydrocarbon radicals can be C₁-C₄-alkyl, C₅-C₆-cycloalkyl, C₅-C₆-cycloalkyl-C₁-C₄-alkyl, phenyl or benzyl. The hydrocarbon radicals can contain substituents which are inert toward metallating reagents. Examples are C₁-C₄-alkyl, C₁-C₄-alkoxy and C₁-C₄-alkylthio.

In a preferred embodiment, R₁ is H or, as alkyl, C₁-C₄-alkyl, particularly preferably methyl.

In a mercaptan radical R₁, the hydrocarbon radical preferably contains from 1 to 12, more preferably from 1 to 8 and particularly preferably from 1 to 6, carbon atoms. The mercaptan radical can, for example, correspond to the formula R₀₀S—, where R₀₀ can independently have one of the meanings of R₁ as hydrocarbon radical, including the preferences.

The silyl radical R₁ can contain identical or different hydrocarbon radicals and preferably corresponds to the formula R₀₁R₀₂R₀₃Si—, where R₀₁, R₀₂ and R₀₃ are each, independently of one another, C₁-C₁₂-alkyl, unsubstituted or C₁-C₄-alkyl- or C₁-C₄-alkoxy-substituted C₆-C₁₀-aryl or C₇-C₁₂-aralkyl. Alkyl radicals R₀₁, R₀₂ and R₀₃ can be linear or branched and preferably contain from 1 to 8 and particularly preferably from 1 to 4 carbon atoms. Aryl radicals R₀₁, R₀₂ and R₀₃ can be, for example, phenyl or naphthyl and aralkyl radicals R₀₁, R₀₂ and R₀₃ can be benzyl or phenylethyl. Some examples of R₀₁, R₀₂ and R₀₃ are methyl, ethyl, n- or i-propyl, n-, i- or t-butyl, pentyl, hexyl, heptyl, octyl, nonyl, decyl, undecyl, dodecyl, phenyl, benzyl, methylphenyl, methylbenzyl, methoxyphenyl, dimethoxyphenyl and methoxybenzyl. Some preferred examples of silyl groups R₀₁R₀₂R₀₃Si— are trimethylsilyl, tri-n-butylsilyl, t-butyldimethylsilyl, 2,2,4,4-tetramethylbut-4-yldimethylsilyl and triphenylsilyl.

The secondary phosphino group R₁ can contain two identical or two different hydrocarbon radicals. The secondary phosphino group R₁ preferably contains two identical hydrocarbon radicals.

The hydrocarbon radicals can be unsubstituted or substituted and/or contain heteroatoms selected from the group consisting of O, S, —N═ and N(C₁-C₄-alkyl). They can contain from 1 to 22, preferably from 1 to 12 and particularly preferably from 1 to 8, carbon atoms. A preferred secondary phosphino group is one in which the phosphino group contains two identical or different radicals selected from the group consisting of linear or branched C₁-C₁₂-alkyl; unsubstituted or C₁-C₆-alkyl- or C₁-C₆-alkoxy-substituted C₅-C₁₂-cycloalkyl or C₅-C₁₂-cycloalkyl-CH₂—; phenyl, naphthyl, furyl or benzyl; and C₁-C₆-alkyl-, trifluromethyl-, C₁-C₆-alkoxy-, trifluoromethoxy-, (C₆H₅)₃Si—, (C₁-C₁₂-alkyl)₃Si— or sec-amino-substituted phenyl or benzyl.

Examples of alkyl substituents on P, which preferably contain from 1 to 6 carbon atoms, are methyl, ethyl, n-propyl, i-propyl, n-butyl, i-butyl, t-butyl and the isomers of pentyl and hexyl. Examples of unsubstituted or alkyl-substituted cycloalkyl substituents on P are cyclopentyl, cyclohexyl, methylcyclohexyl and ethylcyclohexyl and dimethylcyclohexyl. Examples of alkyl- and alkoxy-substituted phenyl and benzyl substituents on P are methylphenyl, dimethylphenyl, trimethylphenyl, ethylphenyl, methylbenzyl, methoxyphenyl, dimethoxyphenyl, trimethoxyphenyl, trifluoromethylphenyl, bistrifluoromethylphenyl, tristrifluoromethylphenyl, trifluoromethoxyphenyl, bistrifluoromethoxyphenyl and 3,5-dimethyl-4-methoxyphenyl.

Preferred secondary phosphino groups are those containing identical radicals selected from the group consisting of C₁-C₆-alkyl, cyclopentyl and cyclohexyl which may be unsubstituted or substituted by from 1 to 3 C₁-C₄-alkyl or C₁-C₄-alkoxy radicals, benzyl and in particular phenyl which are unsubstituted or substituted by from 1 to 3 C₁-C₄-alkyl, C₁-C₄-alkoxy, C₁-C₄-fluoroalkyl or C₁-C₄-fluoroalkoxy.

The secondary phosphino group preferably corresponds to the formula —PR₃R₄, where R₃ and R₄ are each, independently of one another, a hydrocarbon radical which has from 1 to 18 carbon atoms and is unsubstituted or substituted by C₁-C₆-alkyl, trifluoromethyl, C₁-C₆-alkoxy, trifluoromethoxy, (C₁-C₄-alkyl)₂amino, (C₆H₅)₃Si, (C₁-C₁₂-alkyl)₃Si, and/or contains heteroatoms O.

R₃ and R₄ are preferably identical radicals selected from the group consisting of linear or branched C₁-C₆-alkyl, cyclopentyl or cyclohexyl which may be unsubstituted or substituted by from one to three C₁-C₄-alkyl or C₁-C₄-alkoxy radicals, furyl, benzyl which may be unsubstituted or substituted by from one to three C₁-C₄-alkyl or C₁-C₄-alkoxy radicals and in particular phenyl which may be unsubstituted or substituted by from one to three C₁-C₄-alkyl, C₁-C₄-alkoxy, C₁-C₄-fluoroalkyl or C₁-C₄-fluoroalkoxy radials.

R₃ and R₄ are particularly preferably identical radicals selected from the group consisting of C₁-C₆-alkyl, cyclopentyl, cyclohexyl, furyl and phenyl which may be unsubstituted or substituted by from one to three C₁-C₄-alkyl, C₁-C₄-alkoxy and/or C₁-C₄-fluoroalkyl radicals.

The secondary phosphino group R₁ can be cyclic secondary phosphino, for example a group of the formulae

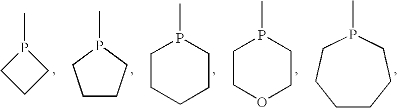

which are unsubstituted or substituted by one or more C₁-C₈-alkyl, C₄-C₈-cycloalkyl, C₁-C₆-alkoxy, C₁-C₄-alkoxy-C₁-C₄-alkyl, phenyl, C₁-C₄-alkylphenyl or C₁-C₄-alkoxyphenyl, benzyl, C₁-C₄-alkylbenzyl or C₁-C₄-alkoxybenzyl, benzyloxy, C₁-C₄-alkylbenzyloxy or C₁-C₄-alkoxy-benzyloxy or C₁-C₄-alkylidenedioxyl radicals.

The substituents can be bound to the P atom in one or both a positions in order to introduce chiral carbon atoms. The substituents in one or both a positions are preferably C₁-C₄-alkyl or benzyl, for example methyl, ethyl, n- or i-propyl, benzyl or —CH₂—O—C₁-C₄-alkyl or —CH₂—O—C₆-C₁₀-aryl.

Substituents in the β, γ positions can be, for example, C₁-C₄-alkyl, C₁-C₄-alkoxy, benzyloxy or —O—CH₂—O—, —O—CH(C₁-C₄-alkyl)-O— and —O—C(C₁-C₄-alkyl)₂-O—. Some examples are methyl, ethyl, methoxy, ethoxy, —O—CH(methyl)-O— and —O—C(methyl)₂-O—.

Depending on the type of substitution and number of substituents, the cyclic phosphino radicals can be C-chiral, P-chiral or C- and P-chiral.

An aliphatic 5- or 6-membered ring or benzene can be fused onto two adjacent carbon atoms in the radicals of the above formulae.

The cyclic secondary phosphino group can, for example, correspond to the formulae (only one of the possible diastereomers shown),

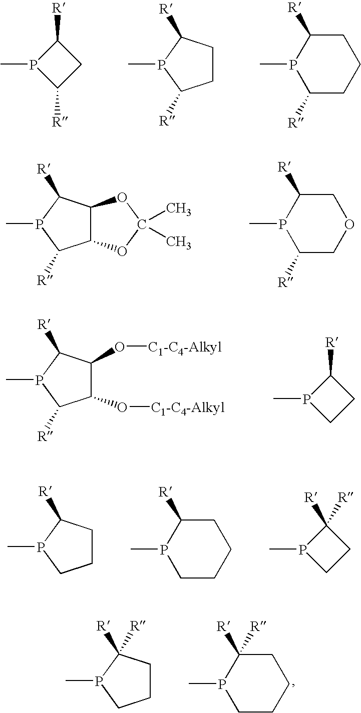

where
the radicals R′ and R″ are each C₁-C₄-alkyl, for example methyl, ethyl, n- or i-propyl, benzyl or —CH₂—O—C₁-C₄-alkyl or —CH₂—O—C₆-C₁₀-aryl, and R′ and R″ are identical, or different.

In the compounds of the formulae I and II, a phosphino group R₁ is preferably acyclic sec-phosphino selected from the group consisting of —P(C₁-C₆-alkyl)₂, —P(C₅-C₈-cycloalkyl)₂, —P(C₇-C₈-bicycloalkyl)₂, —P(C₅-C₈-cycloalkyl)₂, —P(o-furyl)₂, —P(C₆H₅)₂, —P[2-(C₁-C₆-alkyl)C₆H₄]₂, —P[3-(C₁-C₆-alkyl)C₆H₄]₂, —P[4-(C₁-C₆-alkyl)C₆H₄]₂, —P[2-(C₁-C₆-alkoxy)C₆H₄]₂, —P[3-(C₁-C₆-alkoxy)C₆H₄]₂, —P[4-(C₁-C₆-alkoxy)C₆H₄]₂, —P[2-(trifluoromethyl)C₆H₄]₂, —P[3-(trifluoromethyl)C₆H₄]₂, —P[4-(trifluoromethyl)C₆H₄]₂, —P[3,5-bis(trifluoromethyl)C₆H₃]₂, —P[3,5-bis(C₁-C₆-alkyl)₂C₆H₃]₂,

—P[3,5-bis(C₁-C₆-alkoxy)₂C₆H₃]₂ and —P[3,5-bis(C₁-C₆-alkyl)₂-4-(C₁-C₆-alkoxy)C₆H₂]₂, or cyclic phosphino selected from the group consisting of

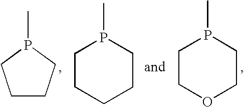

which is unsubstituted or substituted by one or more C₁-C₄-alkyl, C₁-C₄-alkoxy, C₁-C₄-alkoxy-C₁-C₂-alkyl, phenyl, benzyl, benzyloxy or C₁-C₄-alkylidenedioxyl radicals.

Some specific examples are —P(CH₃)₂, —P(i-C₃H₇)₂, —P(n-C₄H₉)₂, —P(i-C₄H₉)₂, —P(t-C₄H₉)₂, —P(C₅H₉), —P(C₆H₁₁)₂, —P(norbornyl)₂, —P(o-furyl)₂, —P(C₆H₅)₂, P[2-(methyl)C₆H₄]₂, P[3-(methyl)C₆H₄]₂, —P[4-(methyl)C₆H₄]₂, —P[2-(methoxy)C₆H₄]₂, —P[3-(methoxy)C₆H₄]₂, —P[4-(methoxy)C₆H₄]₂, —P[3-(trifluoromethyl)C₆H₄]₂, —P[4-(trifluoromethyl)C₆H₄]₂, —P[3,5-bis(trifluoromethyl)C₆H₃]₂, —P[3,5-bis(methyl)₂C₆H₃]₂, —P[3,5-bis(methoxy)₂C₆H₃]₂ and —P[3,5-bis(methyl)₂-4-(methoxy)C₆H₂]₂ and groups of the formulae

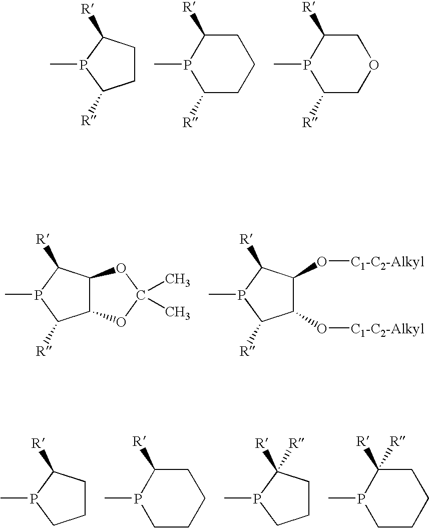

where
R′ is methyl, ethyl, methoxy, ethoxy, phenoxy, benzyloxy, methoxymethyl, ethoxymethyl or benzyloxymethyl and R″ has the same meanings as R′.

For the purposes of the invention, a radical of an electrophilic compound is any reactive reagent which can be bound with replacement of a metal bound to the cyclopentadienyl ring, with catalysts being able to be used if appropriate and monovalent radicals R₂ being able to be formed only in a subsequent step after addition of the reagent (for example hydrolysis).

Such reagents are widely known in organometallic chemistry and have been widely described for metallated aromatic hydrocarbons, see, for example, V. Snieckus, Chem. Rev., 90 (1990) 879-933; Manfred Schlosser (Editor), Organometalics in Synthesis, A. Manual, second edition, John Wiley & Sons, LTD, (2002); Organolithiums: Selectivity for Synthesis (Tetrahedron Organic Chemistry Series) chapter 6 & 7, Pergamon Press (2002) and Kagan, H. B., et al., J. Org. Chem., 62 (1997) 6733-45 (examples of the introduction of a selection of possible electrophilic compounds into metallated ferrocenes).

Examples of reactive electrophilic compounds for the formation of radicals R₂ are:

halogens (Cl₂, Br₂, I₂), interhalogens (Cl—Br, Cl—I) and aliphatic, perhalogenated hydrocarbons (Cl₃C—CCl₃ or BrF₂C—CF₂Br, N-fluorobis(phenyl)sulfonylamine) for introduction of F, Cl, Br or I;
CO₂ for introduction of the carboxyl group —CO₂H;
chlorocarbonates or bromocarbonates [Cl—C(O)—ORₓ] for introduction of a carboxylate group, where Rₓ is a hydrocarbon radical (alkyl, cycloalkyl, cycloalkylalkyl, aryl, aralkyl, heteroaryl, heteroaralkyl) which has from 1 to 18, preferably from 1 to 12 and particularly preferably from 1 to 8, carbon atoms and is unsubstituted or substituted by inert substituents such as sec-phosphino, di(C₁-C₈-alkyl)₂N—, —C(O)—OC₁-C₈-alkyl, or —OC₁-C₈-alkyl (reactive groups such as Cl, Br or I are also considered to be inert substituents when groups which are more reactive toward a metal or a metal group in compounds of the formula I, for example —CHO, are simultaneously present or when Cl and Br, Cl and I or Br and I are simultaneously bound to a preferably aromatic hydrocarbon radical);
di(C₁-C₄-alkyl)formamides, for example dimethylformamide or diethylformamide, for introduction of the —CH(O) group;
di(C₁-C₄-alkyl)carboxamides for introduction of a —C(O)—Rₓ, group;
aldehydes which may be substituted by sec-phosphino in the group Rₓ for introduction of a —CH(OH)—Rₓ, group or paraformaldehyde for introduction of the —CH₂OH group;
symmetrical or unsymmetrical ketones which may be substituted by sec-phosphino in the group Rₓ or Rₐ for introduction of a —C(OH)RₓRₐ group, where Rₐ independently has one or the meanings of Rₓ, or Rₓ and Rₐ together form a cycloaliphatic ring having from 3 to 8 ring atoms;
epoxides for introduction of a —C—C—OH group in which the carbon atoms may be substituted by H or R;
Eschenmoser salt of the formula (CH3)2N+═CH2xI— for introduction of the CH₂—N(CH₃)₂ group;
imines Rₓ—CH═N—Rₐ for introduction of the —CH(R)—NHRₐ group, where Rₐ independently has one of meanings of Rₓ or Rₓ and Rₐ together form a cycloaliphatic ring having from 3 to 8 ring atoms; Rₓ and Rₐ are not simultaneously hydrogen;
imines. Rₓ—C(R_{b})═N—Rₐ for introduction of the —C(Rₓ)(R_{b})—NH Rₐ group, where Rₐ independently has one of meanings of Rₓ or Rₓ and Rₐ together form a cycloaliphatic ring having from 3 to 8 ring atoms, R_{b} independently has one of meanings of Rₓ or Rₓ and R_{b} together form a cycloaliphatic ring having from 3 to 8 ring atoms;
hydrocarbon and heterohydrocarbon monohalides, in particular chlorides, bromides and iodides, for introduction of hydrocarbon and heterohydrocarbon radicals (for example C₁-C₁₈-alkyl, C₆-C₁₄-aryl, C₇-C₁₄-aralkyl);
halogenated hydrocarbons and halogenated heterohydrocarbons having halogen atoms of differing reactivity, in particular combinations of chlorine with bromine or iodine, bromine with iodine or two bromine or iodine atoms, for introduction of hydrocarbon and heterohydrocarbon radicals (for example C₁-C₁₈-alkyl, C₆-C₁₄-aryl, C₇-C₁₄-aralkyl);
alkenyl halides, in particular chlorides, bromides and iodides, for introduction of alkenyl groups such as allyl and vinyl;
tri(C₁-C₈-alkyl)silyl halides (chlorides, bromides) for introduction of the tri(C₁-C₈-alkyl)Si— group;
di(C₁-C₈-alkyl)silyl dihalides (chlorides, bromides) for introduction of the divalent (C₁-C₈-alkyl)₂Si— group to which two radicals of the formula I are bound (in place of M);
sec-phosphine monohalides (chlorides, bromides) for introduction of secondary phosphino groups, for example introduction of the R₃R₄P— group (diphenylphosphino, di(methylphenyl)phosphino, dicyclohexylphosphino and di-t-butylphosphino);
di(sec-amino)phosphine monohalides (chlorides, bromides) for introduction of di(sec-amino)phosphino groups such as di(dimethylamino)phosphino, di(diethylamino)phosphino, N,N-diethylcyclohexylenediaminephosphino;
phosphoric ester monohalides (chlorides, bromides) for introduction of phosphonic ester groups such as (CH₃O)₂(O)P—, (C₂H₅O)(O)P—, (cyclohexylO)₂(O)P—, (ethylenedioxyl)(O)P—;
phosphorous ester monohalides (chlorides, bromides) for introduction of phosphorous ester groups such as (CH₃O)₂P—, (C₂H₅O)P—, (cyclohexylO)₂P—, (ethylenedioxyl)P—;
sec-arsine monohalides (chlorides, bromides) for introduction of secondary arsino groups such as diphenylarsino, di(methylphenyl)arsino, dicyclohexylarsino and di-t-butylarsino);
organic disulfides R—SS—R for introduction of the —SR group;
sulfur (S₈) for introduction of the —SH group; and
substituted or unsubstituted ferrocenyl monohalides (chlorides, bromides, iodides).

Preferred radicals R₂ are halide (—F, —Cl, —Br, —I), —CO₂H, —C(O)—ORₓ, —C(O)—R, —CH═O, —CH(OH)—Rₓ, —CH₂OH, C₁-C₁₈-alkyl, (C₁-C₈-alkyl)₃Si—, sec-phosphino (as described above for R₁, including the preferences) and RₓS—, where Rₓ is alkyl, cycloalkyl, cycloalkylalkyl, aryl, aralkyl, heteroaryl, heteroaralkyl having from 1 to 12 and preferably from 1 to 8 carbon atoms.

Particularly preferred radicals R₂ are F, —Cl, —Br, C₁-C₄-alkyl, phenyl, benzyl, (C₁-C₄-alkyl)₃Si—, RS— where R is C₁-C₄-alkyl or phenyl, and sec-phosphino.

In the ortho-directing, chiral group Y, the chiral atom is preferably bound in the 1, 2 or 3 position relative to the cyclopentadienyl-Y bond. The group Y can be a substituted or unsubstituted open-chain radical having a total of from 1 to 20 and preferably from 1 to 12 atoms or a cyclic radical having 4 or 8 ring atoms and a total of from 4 to 20 and preferably from 4 to 16 atoms, with the atoms being selected from the group consisting of C, O, S, N and P and carbon atoms being saturated with hydrogen.

The group Y can, for example, be a sulfoxyl radical of the formula —S*(═O)—R₁₀, where R₁₀ is C₁-C₈-alkyl, preferably C₂-C₆-alkyl, or C₅-C₈-cycloalkyl or C₆-C₁₀-aryl. Some examples are methylsulfoxyl, ethylsulfoxyl, n- or i-propylsulfoxyl and n-, i- or t-butylsulfoxyl and phenylsulfoxyl.

The group. Y can, for example, correspond to the formula —HC*R₅R₆ (* denotes the chiral atom), where R₅ is C₁-C₈-alkyl, C₅-C₈-cycloalkyl, phenyl or benzyl, R₆ is —OR₇ or —NR₈R₉, R₇ is C₁-C₈-alkyl, C₅-C₈-cycloalkyl, phenyl or benzyl and R₈ and R₉ are identical or different and are each C₁-C₈-alkyl, C₅-C₈-cycloalkyl, phenyl or benzyl or R₈ and R₉ together with the N atom form a five- to eight-membered ring. R₅ is preferably C₁-C₄-alkyl such as methyl, ethyl, n-propyl and phenyl. R₇ is preferably C₁-C₄-alkyl such as methyl, ethyl, n-propyl and n- or i-butyl. R₈ and R₉ are preferably identical radicals and are preferably each C₁-C₄-alkyl such as methyl, ethyl, n-propyl and n- or i-butyl or together form tetramethylene, pentamethylene or 3-oxa-1,5-pentylene. Particularly preferred groups of the formula

—HCR₅R₆ are 1-methoxyeth-1-yl, 1-dimethylaminoeth-1-yl and 1-(dimethylamino)-1-phenylmethyl.

When Y is an achiral, ortho-directing group —CH₂—N(C₁-C₄-alkyl), then the alkyl group is preferably linear alkyl and very particularly preferably methyl or ethyl.

When Y is an achiral, ortho-directing group —CH₂—OR, then R is preferably an alkyl group, preferably linear alkyl and very particularly preferably methyl or ethyl.

When Y is a radical without α chiral a carbon atom, it is bound to the cyclopentadienyl ring via a carbon atom either directly or via a bridging group. The bridging group can be, for example, methylene, ethylene or an imine group. Cyclic radicals bound to the bridging group are preferably saturated and are particularly preferably C₁-C₄-alkyl-, (C₁-C₄-alkyl)₂NCH₂—, (C₁-C₄-alkyl)₂NCH₂CH₂—, C₁-C₄-alkoxymethyl- or C₁-C₄-alkoxyethyl-substituted N—, O— or N,O-heterocycloalkyl having a total of 5 or 6 ring atoms. Open-chain radicals are preferably bound to the cyclopentadienyl ring via a CH₂ group and the radicals are preferably derived from amino acids or ephedrine. Some preferred examples are:

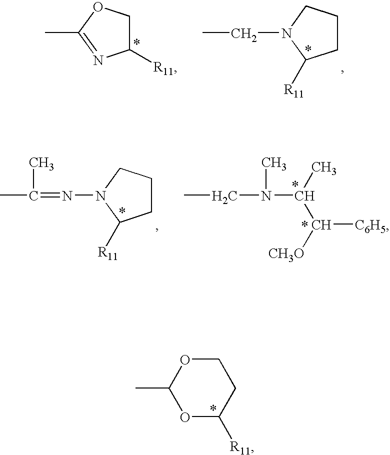

where R₁₁ is C₁-C₄-alkyl, phenyl, (C₁-C₄-alkyl)₂NCH₂—, (C₁-C₄-alkyl)₂NCH₂CH₂—, C₁-C₄-alkoxymethyl or C₁-C₄-alkoxyethyl. R₁₁ is particularly preferably methoxymethyl or dimethylaminomethyl.

P-bonded chiral groups Y are preferably BH₃-protected diaminophosphino in which N-hetero-cycloalkyl which has a total of 4, 5, 6 or 7 ring atoms and is substituted by C₁-C₄-alkyl, C₁-C₄-alkoxymethyl or C₁-C₄-alkoxyethyl in the a position relative to the N atom or a 1,2-diamino-C₄-C₇-cycloalkyl radical is bound to the phosphorus atom or in which an N,N′-substituted diamine is bound to the phosphorus atom so as to form, together with the P atom, an N,P,N-heterocycloaliphatic ring having from 4 to 7 ring atoms and further substituents may be bound to carbon atoms. Suitable open-chain substituents on the phosphorus atom are, for example, —N(C₁-C₄-alkyl)-C₂-C₄-alkylene-N(C₁-C₄-alkyl)₂.

Particularly preferred diaminophosphino groups correspond to the formulae

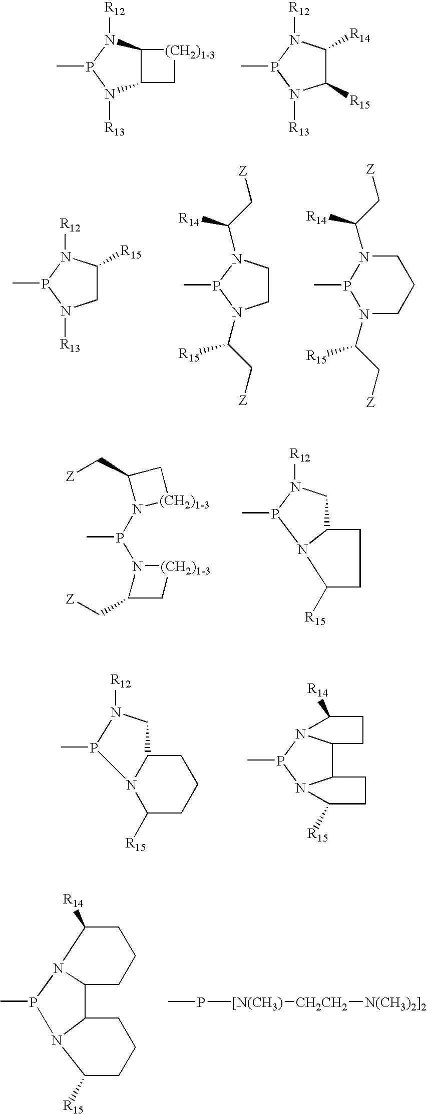

where
R₁₂ and R₁₃ are identical or different, preferably identical, and are each C₁-C₄-alkyl, C₁-C₄-alkoxyethyl, (C₁-C₄-alkyl)₂N-ethyl,
R₁₄ and R₁₅ are identical or different, preferably identical, and are each H, C₁-C₄-alkyl, phenyl or methylphenyl and
Z is H, C₁-C₄-alkyl, C₁-C₄-alkoxy, C₁-C₄-alkylthio, —N(C₁-C₄-alkyl)₂, phenyl, phenoxy, methoxyphenyl or methoxyphenoxy. Some further examples of Z are methyl, ethyl, methoxy, ethoxy, methylthio and dimethylamino.

Diaminophosphino groups are advantageously protected with borane (BH₃) which can easily be removed again.

P-bonded chiral groups Y can also be P(V)-radicals, for example radicals containing the structure element —O—P(O)—N—, where the O and N atoms are substituted by monovalent hydrocarbon radicals or the O and N atoms are linked by a substituted or unsubstituted C₂-C₄-alkylene chain.

The invention further provides a process for preparing compounds of the formulae I and II, which comprises the steps:
a) reaction of a compound of the formula III

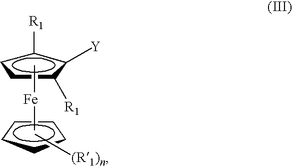

where
(a1) R′₁, n and R₁ are as defined above and one of the radicals R₁ is a hydrogen atom, Y is as defined above with the exception of Y=vinyl, methyl, ethyl or
(a2) R′₁, n and R₁ are as defined above and both radicals R₁ are hydrogen atoms and Y is a C-, S- or P-bonded chiral group which directs metals of metallizing reagents into the ortho position X₁,
firstly with at least equivalent amounts of an alkyllithium or a magnesium Grignard compound and then with at least equivalent amounts of a halogenating reagent to form a compound of the formula IV or V,

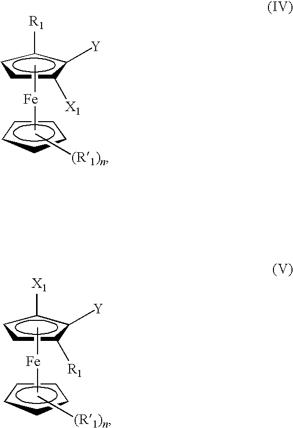

where X₁ is F, Cl, Br or I,
b) reaction of a compound of the formula IV or V or a compound of the formula IV or V in which Y is vinyl, methyl, ethyl with at least equivalent amounts of an aliphatic lithium sec-amide or a halomagnesium sec-amide to form compounds of the formula VI or VII,

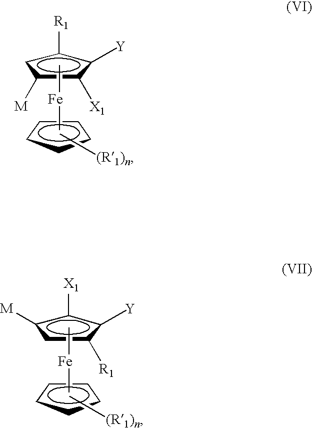

where M is Li or —MgX₂ and X₂ is Cl, Br or I,
c) reaction of a compound of the formula VI or VII with an electrophilic organic compound to introduce the monovalent radical R₂ and form the compounds of the formula I or II.

The metallation of ferrocenes as in process step a) is a known reaction which is described, for example, by T. Hayashi et al., Bull. Chem. Soc. Jpn. 53 (1980), pages 1138 to 1151, or in Jonathan Clayden Organolithiums: Selectivity for Synthesis (Tetrahedron Organic Chemistry Series), Pergamon Press (2002). The alkyl in the alkyllithium can, for example, contain from 1 to 4 carbon atoms. Methyllithium and butyllithium are frequently used. Magnesium Grignard compounds are preferably compounds of the formula (C₁-C₄-alkyl)MgX₀, where X₀ is Cl, Br or I.

For the purposes of the invention, the expression at least equivalent amounts means the use of from 1 to 1.5 equivalents of alkyllithium or a magnesium Grignard compound per ═CH— group in the ortho position relative to the group Y in the cyclopentadienyl ring.

The reaction is advantageously carried out at low temperatures, for example from 20 to −100° C., preferably from 0 to −80° C. The reaction time is from about 1 to 20 hours. The reaction is advantageously carried out under an inert protective gas, for example nitrogen or noble gases such as argon.

The reaction is advantageously carried out in the presence of inert solvents. Such solvents can be used either alone or as a combination of at least two solvents. Examples of solvents are aliphatic, cycloaliphatic and aromatic hydrocarbons and also open-chain or cyclic ethers. Specific examples are petroleum ether, pentane, hexane, cyclohexane, methylcyclohexane, benzene, toluene, xylene, diethyl ether, dibutyl ether, tert-butyl methyl ether, ethylene glycol dimethyl or diethyl ether, tetrahydrofuran and dioxane.

Compounds of the formula III are known or can be prepared by known or analogous methods. The preparation starts out from monolithiated ferrocenes which are reacted with a Y-halogen compound (halogen is F, Cl and preferably Br or I, Y is not methyl, ethyl or vinyl). Subsequent to the reaction, borane BH₃ can, if its presence is desired, be introduced into a diamino-phosphino group in a known manner, for example by reaction of the reaction mixture with a borane complex such as BH₃S(CH₃)₂. Diaminophosphino chlorides or bromides are known or can be obtained in a manner known per se from phosphorus trichloride by reaction with amines or diamines.

The halogenation in process step a) is generally carried out immediately after the metallation in the same reaction mixture, using reaction conditions similar to those in the metallation. For the purposes of the invention, the expression at least equivalent amount means the use of preferably from 1 to 1.4 equivalents of a halogenating reagent. Halogenating reagents are, for example, halogens (Cl₂, Br₂, I₂), interhalogens (Cl—Br, Cl—I) and aliphatic, perhalogenated hydrocarbons (Cl₃C—CCl₃, Br₂HC—CHBr₂ or BrF₂C—CF₂Br) for introduction of Cl, Br or I; or N-fluorobis(phenyl)sulfonylamine for introduction of fluorine.

The metallation in process step a) and the halogenation proceed regioselectively and the compounds of the formulae III and IV are obtained in high yields. The reaction is also stereoselective due to the presence of the chiral group Y. Furthermore, if necessary, optical isomers can also be separated at this stage, for example by chromatography using chiral columns.

In process step b), the ferrocene skeleton is once again regioselectively metallated in the same cyclopentadienyl ring in the ortho position relative to the halogen atom X₁. Here, metal amides are sufficient to replace the acidic H atom in the ortho position relative to the halogen atom X₁. For the purposes of the invention, the expression at least equivalent amounts means the use of from 1- to 5 equivalents of an aliphatic lithium sec-amide or an X₂Mg sec-amide per CH group in the cyclopentadienyl ring of the ferrocene.

Aliphatic lithium sec-amide or X₂Mg sec-amide can be derived from secondary amines containing from 2 to 18, preferably from 2 to 12 and particularly preferably from 2 to 10, carbon atoms. The aliphatic radicals bound to the N atom can be alkyl, cycloalkyl or cycloalkyl-alkyl or they can be N-hetreocyclic rings having 4 to 12, preferably 5 to 7, carbon atoms. Examples of radicals bound to the N atom are methyl, ethyl, n- and i-propyl, n-butyl, pentyl, hexyl, cyclopentyl, cyclohexyl and cyclohexylmethyl. Examples of N-heterocyclic rings are pyrrolidine, piperidine, morpholine, N-methylpiperazine, 2,2,6,6-tetramethylpiperidine and azanorbornane. In a preferred embodiment, the amides correspond to the formulae Li—N(C₃-C₄-alkyl)₂ or X₂Mg—N(C₃-C₄-alkyl)₂, where alkyl is in particular i-propyl. In another preferred embodiment, the amides are Li(2,2,6,6-tetramethylpiperidine).

In process step c), radicals of electrophilic compounds are introduced with replacement of M. Examples of various electrophilic compounds have been given above. For the purposes of the invention, the expression at least equivalent amounts means the use of from 1 to 1.2 equivalents of reactive electrophilic compound per reacting ═CM— group in an aromatic compound. However, it is also possible to use a substantial excess of up to 2.5 equivalents.

The reaction is advantageously carried out at low temperatures, for example from 20 to −100° C., preferably from 0 to −80° C. The reaction is advantageously carried out under an inert protective gas, for example noble gases such as argon or else nitrogen. After addition of the reactive electrophilic compound, the reaction mixture is advantageously allowed to warm to room temperature or is heated to elevated temperatures, for example up to 100° C. and preferably up to 50° C., and is stirred for some time under these conditions in order to complete the reaction.

The reaction is advantageously carried-out in the presence of inert solvents. Such solvents can be used either alone or as a combination of at least two solvents. Examples are solvents are aliphatic, cycloaliphatic and aromatic hydrocarbons and also open-chain or cyclic ethers. Specific examples are petroleum ether, pentane, hexane, heptane, cyclohexane, methylcyclohexane, benzene, toluene, xylene, diethyl ether, dibutyl ether, tert-butyl methyl ether, ethylene glycol dimethyl or diethyl ether, tetrahydrofuran and dioxane.

The compounds of the formulae I and II can be isolated by methods-known per se, for example extraction, filtration and distillation. After isolation, the compounds can be purified, for example by distillation, recrystallization or by chromatographic methods. The compounds of the formulae I and II are obtained in good total yields and high optical purities.

Compounds of the formulae I and II in which Y is vinyl or ethyl can, for example, be prepared by elimination of amines from 1-[(dialkylamino)eth-1-yl]-2-haloferrocenes, for example 1-[(dimethylamino)eth-1-yl]-2-bromoferrocene of the formula

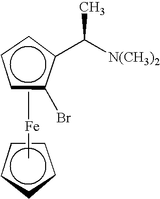

to form 1-vinyl-2-haloferrocene, preferably 1-vinyl-2-bromoferrocene, and, if appropriate, subsequent hydrogenation of the vinyl group formed to an ethyl group. The reaction conditions are described in the examples. The 1-vinyl- or 1-ethyl-2-bromoferrocenes which can be obtained in this way can then be used as starting compounds in process step b). Compounds of the formulae I and II in which Y is a —CH₂—N(C₁-C₄-alkyl)₂ group can be obtained, for example, by replacement of a quaternary CH₂-bonded chiral sec-amino radical by HN(C₁-C₄-alkyl)₂. Examples of such CH₂-bonded sec-amino radicals are radicals of the formulae

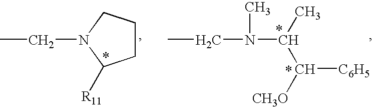

where
R₁₁, is C₁-C₄-alkyl, phenyl, (C₁-C₄-alkyl)₂NCH₂—, (C₁-C₄-alkyl)₂NCH₂CH₂—, C₁-C₄-alkoxymethyl or C₁-C₄-alkoxyethyl. R₁₁, is particularly preferably methoxymethyl or dimethylaminomethyl. Quaternization is advantageously carried out using alkyl halides (alkyl iodides), for example methyl iodide.

Compounds of the formulae I and II in which Y is methyl can be obtained from the known [see T. Arantani et al., Tetrahedron 26 (1970), pages 5453-5464, and T. E. Picket et al., J. Org. Chem. 68 (2003), pages 2592-2599] 1-methyl-2-bromoferrocene as starting compound for the metallation in process step b).

Compounds of the formulae I and II in which Y is —CH₂—OR can be obtained by firstly acoxylating (for example 1-acetyloxy-CH₂—) 1-(C₁-C₄-alkyl)₂NCH₂-2-haloferrocene by means of carboxylic anhydrides, for example acetic anhydride, to form 1-acyloxy-CH₂-2-haloferrocene and then reacting these intermediates with alcohols, if appropriate in the presence of bases, or with alkali metal alkoxides to give 1-RO—CH₂-2-haloferrocene which can then be used in process step b). Compounds of the formulae I and II in which Y is —HCR₅—OR₇ can be obtained in an analogous way by modification of the group Y═—HCR₅—N(C₁-C₄-alkyl)₂ by means of alcohols HOR₇.

The regioselectivity in the metallation in the ortho position relative to the bromine atom for the subsequent introduction of electrophiles is surprisingly essentially retained even in the presence of the groups vinyl, methyl, ethyl, —CH₂—OR and (C₁-C₄-alkyl)₂NCH₂—.

The compounds of the formulae I and II which contain a coordinating group such as sec-phosphino are suitable as monodentate ligands for complexes of transition metals, for example the TM-8 metals of the periodic table of the chemical elements, which can be used as catalysts in coupling reactions in organic chemistry. Thus, T. E. Pickett describes, in J. Org. Chem. 2003, 68, pages 2592 to 2599, the preparation of 1-methyl-2-sec-phosphinoferrocenes as bulky ligands for palladium-catalyzed reactions.

A thiol radical or a secondary phosphino group is preferably present as coordinating groups. The compounds of the formulae I and II which do not have a coordinating group can be modified in a simple fashion by known methods in order to introduce a coordinating group. For example, a hydrogen atom R₁ can be lithiated by means of lithium bases and subsequently reacted with an electrophilic organic compound so as to introduce a coordinating group when there is not yet a coordinating group in the ferrocene. A bromine or iodine atom X₁ can be lithiated by means of an alkyllithium and then reacted with an electrophilic organic compound so as to introduce a coordinating group when there is not yet a coordinating group in the ferrocene.

When the group Y is diaminophosphino, this can be converted into a secondary phosphino group by a) removing the borane group, if present, then cleaving off the diamino radicals to form a —PCl₂ group or —PBr₂ group and then replacing the Cl or Br atoms with a hydrocarbon radical by means of an organometallic compound (Grignard reagent) to form the sec-phosphino group or b) cleaving off the diamino radicals to form a —PCl₂ group or —PBr₂ group and then replacing the Cl or Br atoms with a hydrocarbon radical by means of an organometallic compound Grignard reagent) to form the sec-phosphino group and then removing the borane group. The removal of the borane group only in the last reaction step offers the advantage that reaction-sensitive groups remain protected.

The removal of the borane group can, for example, be effected by addition of reagents such as secondary amines having C₁-C₄-alkyl groups, morpholine, 1,8-diazabicyclo[5.4.0]undec-7-ene (DBU), 1,4-diazabicyclo[2.2.2]octane to the dissolved compound of the formulae III, stirring for a sufficiently long time at temperatures of from 20 to 70° C. and removal of the volatile constituents, advantageously under reduced pressure. Methods of removing borane are described, for example, by M. Ohff et al. in Synthesis (1998), page 1391.

The formation of —PCl₂ or —PBr₂ groups is likewise known and descried, for example, by A. Longeau et al. in Tetrahedron: Asymmetry, 8 (1997) pages 987-990. As reagent, it is advantageous to use organic solutions of HCl or HBr in, for example, ethers and add these solutions to dissolved compounds of the formula I and II, with or without a borane group, at low temperatures (for example from −20 to 30° C.).

The Grignard reagents can be mono- or di-Li—, —ClMg—, —BrMg— or —IMg-hydrocarbons which are generally added in excess, for example up to 5 equivalents per halogen atom. The reaction is carried out in solution, for which purpose it is possible to use solvents as mentioned above for the metallation. The reaction can be carried out at temperatures of from −80 to 80° C.

—PCl₂ groups or —PBr₂ groups can be hydrogenated in a manner known per se, for example by means of Li(AlH₄), and the phosphino group can then be converted into a cyclic secondary phosphino group using, for example, cyclic sulfates such as butylene or propylene sulfate. The monophosphines can be isolated by methods as described above.

A further possible way of introducing coordinating groups (when no such group is present) is to replace bromine or iodine atoms X₁ in the cyclopentadienyl ring by a secondary phosphino group or a thio radical. For this purpose, it is possible firstly to lithiate compounds of the formula I or II in which X₁ is bromine or iodine by means of alkyllithium in a manner known per se (replacement of Br, I) and then to react the resulting intermediates with secondary phosphine halides or organic disulfides.

It is also possible to replace secondary, open-chain or cyclic amino groups in the group Y by a secondary phosphino group in a manner known per se if the ferrocene does not yet contain a coordinating group.

The compounds of the formula I or II are also valuable intermediates for preparing chelating, chiral ligands for transition metals.

The following examples illustrate the invention.

### A) Preparation of Multiply Substituted Ferrocenes

1-[(Dimethylamino)eth-1-yl]ferrocene is commercially available.

1-[(Dimethylamino)eth-1-yl]-2-bromoferrocene of the formula

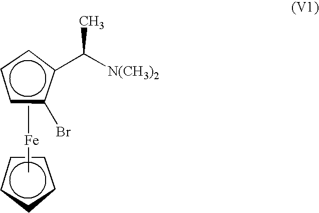

is prepared as described in the literature: J. W Han et al. Helv. Chim. Acta, 85 (2002) 3848-3854. The compound will hereinafter be referred to as V1.

1-[(Dimethylamino)eth-1-yl]-2-diphenylphosphinoferrocene of the formula

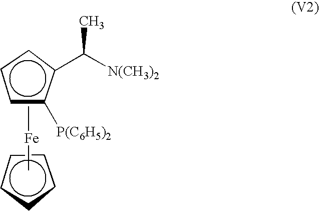

is prepared as described in the literature: T. Hayashi et al., Bull. Chem. Soc. Jpn., 53 (1980) 1138-1151. The compound will hereinafter be referred to as V2.

The reactions are carried out under inert gas (argon).

The reactions and yields are not optimized.

Abbreviations: TMP=2,2,6,6-tetramethylpiperidine; TBME=tert-butyl, methyl ether; DMF═N,N-dimethylformamide; EtOH=ethanol; EA=ethyl acetate; eq=equivalents.

### Preparation of an Li-TMP Solution:

10.5 ml (16.8 mmol) of a 1.6M n-butyllithium solution in hexane are added dropwise to a solution of 3.05 ml (18 mmol) of 2,2,6,6-tetramethylpiperidine in 10 ml of THF at 0° C. The cooling is removed and the reaction mixture is stirred at room temperature for another 45 minutes. This solution can be directly used, further.

### EXAMPLE A1

### 1-[(Dimethylamino)eth-1-yl]-2-bromo-3-methylferrocene (A1) of the Formula

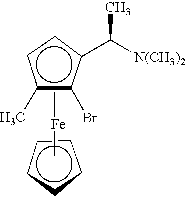

A solution of lithium tetramethylpiperidinide (Li-TMP) [composition: 3.05 ml (18 mmol) of TMP and 10.5 ml (16.8 mmol) of n-butyllithium (n-Bu—Li), 1.6M in hexane in 10 ml of THF] is added dropwise to a solution of 2.015 g (6 mmol) of V1 in 20 ml of TBME at −78° C. while stirring and the reaction mixture is stirred firstly at −78° C. for 10 minutes and subsequently at −40° C. for about 3 hours. After cooling back down to −78° C., 1.12 ml (18 mmol) of methyl iodide are added and the mixture is stirred at −78° C. for another 1 hour. The temperature is then allowed to rise to −10° C. over a period of 70 minutes and 10 ml of water are added. Immediately after this, unreacted methyl iodide is distilled off at room temperature under reduced pressure. The reaction mixture is extracted with an ammonium chloride solution (0.5 N) and TBME. The organic phases are collected, washed with water, dried over sodium sulfate and evaporated to dryness on a rotary evaporator. Purification by column chromatography (silica gel 60; eluent: ethyl acetate) gives the title compound A1 as an orange oil in a yield of 90%. The product still contains some starting compound. ¹H-NMR (C₆D₆, 300 MHz), characteristic signals: 3.88 [s, 5H, cyclopentadiene (cp)], 2.16 (s, 6H, N(CH₃)₂), 1.93 (s, 3H, cp-CH₃), 1.34 (d, 3H, C(NMe₂)CH₃).

### EXAMPLE A2 (REPLACEMENT OF BROMINE ATOM)

### 1-[(Dimethylamino)eth-1-yl]-2-(diphenylphosphino)-3-methylferrocene (A2) of the Formula

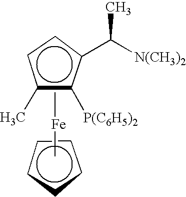

4.1 ml (6.5 mmol) of n-Bu—Li (1.6M solution in hexane) are added dropwise to a solution of 1.9 g (5.42 mmol) of A1 in 19 ml of TBME at 0° C. over a period of 8 minutes while stirring and the reaction mixture is stirred at 0° C. for a further one hour. 1.4 ml (7.6 mmol) of diphenylphosphine chloride are then added dropwise and the mixture is stirred overnight without cooling. The mixture is worked up by extraction with water/methylene chloride. The organic phases are combined, dried over sodium sulfate and evaporated to dryness on a rotary evaporator. Purification by chromatography (silica gel 60; eluent: EA containing 0.5% of triethylamine) gives the title compound. Impurities are removed by recrystallization from EtOH to give the title compound as a yellow-orange powder in a yield of 54%. ¹H-NMR (C₆D₆, 300 MHz), characteristic signals: 7.74-7.69 (m, 2H), 7.44-7.39 (m, 2H), 7.13-7.04 (m, 6H), 4.01 (s, 5H, cp), 1.82 (s, 6H, N(CH₃)₂), 1.56 (s, 3H, cp-CH₃), 1.08 (d, 3H, C(NMe₂)CH₃).

³¹P-NMR (C₆D₆, 121 MHz):−15.9.

### EXAMPLE A3

### 1-[(Dimethylamino)eth-1-yl]-2,3-dibromoferrocene (A3) of the Formula

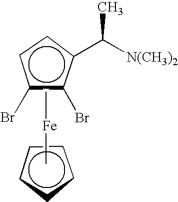

An Li-TMP solution [composition: 0.37 ml (2.2 mmol) of TMP and 1.28 ml (2.05 mmol) of n-Bu—Li (1.6M in hexane) in 2.5 ml of THF] is added dropwise to a solution of 246 mg (0.733 mmol) of V1 in 1 ml of THF at −78° C. while stirring and the reaction mixture is firstly stirred at −78° C. for 10 minutes and subsequently at −40° C. for 3 hours. After cooling back down to −78° C., 0.27 ml (2.2 mmol) of 1,2-dibromotetrafluoroethane is added and the mixture is stirred at −78° C. for a further 1.5 hours. 3 ml of water are then added and the reaction mixture is extracted with TBME. The organic phases are combined, dried over sodium sulfate and the solvent is distilled off under reduced pressure on a rotary evaporator. Purification by; column chromatography (silica gel 60; eluent=acetone) gives the title compound as an orange-brown oil in a yield of 62% of theory. ¹H-NMR (C₆D₆, 300 MHz), characteristic signals: 4.17 (m, 1H), 3.93 (s, 5H, cp), 3.71 (q, 1H), 3.64 (m, 1H), 2.06 (s, 6H, N(CH₃)₂), 1.17 (d, 3H, C(NMe₂)CH₃).

### EXAMPLE A4 (REPLACEMENT OF BROMINE ATOM)

### 1-[(Dimethylamino)eth-1-yl]-2-(diphenylphosphino)-3-bromoferrocene (A4) of the Formula

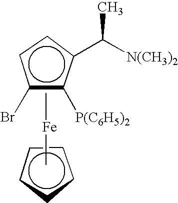

0.27 ml (0.432 mmol) of n-Bu—Li (1.6M solution in hexane) is added dropwise to a solution of 171 mg (0.411 mmol) of A3 in 2 ml of TBME at −78° C. while stirring and the reaction mixture is stirred at −78° C. for a further 2 hours. 0.092 ml (0.49 mmol) of diphenylphosphine chloride is then added and the reaction mixture is stirred at −78° C. for 0.5 hour. The cooling is removed and the reaction mixture is stirred overnight. The mixture is worked up by addition of water and extraction with methylene chloride. The organic phases are combined, dried over sodium sulfate and the solvent is distilled off under reduced pressure on a rotary evaporator. Column chromatography (silica gel 60; eluent=firstly ethyl acetate, then acetone) gives two main fractions. One fraction contains the title compound as an orange-yellow product. ¹H-NMR (C₆D₆, 300 MHz), characteristic signals: 7.90-7.84 (m, 2H), 7.54-7.48 (m, 2H), 7.18-7.0 (m, 6H), 4.34 (d, 1H), 4.02 (s, 5H, cp), 4.01-3.94 (m, 2H), 1.80 (s, 6H, N(CH₃)₂), 0.96 (d, 3H, C(NMe₂)CH₃). ³¹P-NMR (C₆D₆, 121 MHz): −14.3.

The other fraction contains the compound 1-[(dimethylamino)eth-1-yl]-2-bromo-3-(diphenylphosphino)ferrocene. ¹H-NMR (C₆D₆, 300 MHz), characteristic signals: 7.65-7.59 (m, 2H), 7.38-7.32 (m, 2H), 7.11-7.0 (m, 6H), 4.02 (s, 5H, cp), 2.18 (s, 6H, N(CH₃)₂), 1.32 (d, 3H, C(NMe₂)CH₃). ³¹P-NMR (C₆D₆, 121 MHz): −18.4.

### EXAMPLE A5

### 1-[(Dimethylamino)eth-1-yl]-2-bromo-3-(dicyclohexylphosphino)ferrocene (A5) of the Formula

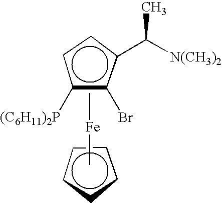

11.2 ml (66.9 mmol) of 2,2-6,6-tetramethylpiperidine (98%) are dissolved in 100 ml of absolute THF and cooled to 0° C. 40.0 ml (64.7 mmol) of n-Bu—Li solution (1.6M in hexane) are added dropwise. The mixture is subsequently stirred at 0° C. for one hour (solution A). 7.46 g (22.3 mmol, 1.0 eq) of V1 are dissolved in 60 ml of absolute THF and cooled to −60° C. (solution B). Solution A is then added dropwise to solution B over a period of 30 minutes and the mixture is stirred for 1.5 hours, with the temperature being allowed to rise to −40° C. The reaction mixture is cooled to −78° C. and 6.00 ml (26.9 mmol) of dicyclohexylphosphine chloride are added. After stirring at −78° C. for a further 2.5 hours, 150 ml of water are added and the organic phase is then isolated. The aqueous phase is acidified with saturated ammonium chloride solution and extracted with 100 ml of TBME. The combined organic phases are dried over sodium sulfate and freed of the solvent. The brown oil obtained is purified by chromatography [silica gel, acetone:heptane (1:2)]. This gives 9.75 g (82%) of the title compound as a brown oil. ¹H-NMR (C₆D₆, 300 MHz), characteristic signals: 4.05 (s, 5H, cp), 2.16 (s, 6H, N(CH₃)₂), 1.35-(d, 3H, C(NMe₂)CH₃). ³¹P-NMR (C₆D₆, 121 MHz): −9.3 (s).

### EXAMPLE A6

### 1-[(Dimethylamino)eth-1-yl]-2-(diphenylphosphino)-5-bromoferrocene (A6) of the Formula

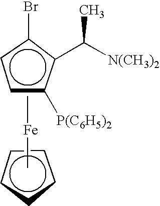

A solution of 2 g (4.55 mmol) of V2 in 10 ml of TBME is cooled to −50° C. while stirring. 4 ml of t-Bu—Li (1.5M in hexane) is added dropwise to this mixture over a period of 30 minutes. The temperature is subsequently allowed to rise slowly to 0° C. A homogeneous solution is obtained. After stirring at 0° C. for 1 hour, the temperature is reduced to −70° C. and 1.66 g of 1,2-dibromoteotrafluoroethane dissolved in 3 ml of TBME are added dropwise over a period of 20 minutes. The temperature is subsequently allowed to rise slowly to room temperature and the reaction mixture is then stirred overnight. The reaction mixture is admixed with 5 ml of water and extracted a number of times, with TBME. The organic phases are combined and dried over sodium sulfate. Distilling off the solvent under reduced pressure on a rotary evaporator gives the title compound as an orange-brown solid in a yield of 84%. ¹H-NMR (C₆D₆, 300 MHz), characteristic signals: 7.61-7.56 (m, 2H), 7.31-7.26 (m, 2H), 7.10-7.01 (m, 6H), 4.46 (m, 1H), 4.33 (m, 1H), 3.91 (s, 5H, cp), 3.73 (m, 1H), 1.97 (s, 6H, N(CH₃)₂), 1.60 (d, 3H, C(NMe₂)CH₃). ³¹P-NMR (C₆D₆, 121 MHz): −20.9.

### EXAMPLE A7

### 1-[(Dimethylamino)eth-1-yl]-2-(diphenylphosphino)-4-trimethylsilyl-5-bromo-ferrocene (A7) of the Formula

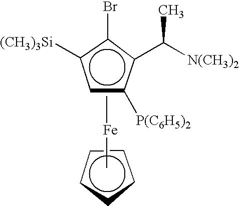

An Li-TMP solution [composition: 0.5 ml (2.9 mmol) of TMP, 1.7 ml (2.71 mmol) of n-Bu—Li, 1.6M in hexane, 3 ml of THF] is added dropwise to a solution of 504 mg (0.97 mmol) of A6 in 2 ml of THF at −70° C. while stirring and the reaction mixture is stirred firstly at −70° C. for 10 minutes and subsequently at −40° C. for 2.5 hours. After cooling back down to −78° C., 0.2 ml (1.45 mmol) of trimethylchlorosilane is added and the mixture is stirred at, −40° C. for a further 1.5 hours. The reaction is then stopped by addition of 3 ml of water and the mixture is extracted a number of times with methylene chloride. The organic phases are collected, dried over sodium sulfate and the solvent is distilled off under reduced pressure on a rotary evaporator. Purification by chromatography (silica gel 60; eluent=heptane/TBME 4:1) gives the title compound as a solid in a yield of 75%. Recrystallization from methanol gives a yellow crystalline product. ¹H-NMR (C₆D₆, 300 MHz), characteristic signals: 7.68-7.63 (m, 2H), 7.35-7.30 (m, 2H), 7.10-6.98 (m, 6H), 4.52 (m, 1H), 3.99 (s, 5H, cp), 3.92 (s, 1H), 1.99 (s, 6H, N(CH₃)₂), 1.62 (d, 3H, C(NMe₂)CH₃), 0.32 (s, 9H, Si(CH₃)₃). ³¹P-NMR (C₆D₆, 121 MHz): −20.3 (s).

### EXAMPLE A8 (REPLACEMENT OF BROMINE ATOM)

### 1-[(Dimethylamino)eth-1-yl]-2-(diphenylphosphino)-4-trimethylsilylferrocene (A8) of the Formula

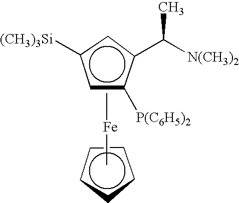

0.11 ml of n-Bu—Li (1.6M solution in hexane) is added dropwise to a solution of 98 mg (0.165 mmol) of A7 in 1.5 ml of TBME at 0° C. while stirring and the mixture is stirred at 0° C. for a further 1 hour. After addition of 10 microliters of water, the mixture is stirred overnight at room temperature. The reaction mixture is then extracted with water/TBME, the organic phases are dried over sodium sulfate and the solvent is distilled off under reduced pressure on a rotary evaporator. The title compound has a purity of >95% and the yield is virtually quantitative. ¹H-NMR (C₆D₆, 300 MHz), characteristic signals: 7.80-7.74 (m, 2H), 7.42-7.36 (m, 2H), 7.14-6.99 (m, 6H), 4.35 (m, 1H), 4.29 (m, 1H), 4.03 (m, 1H), 3.95 (s, 5H, cp), 1.89 (s, 6H, N(CH₃)₂), 1.15 (d, 3H, C(NMe₂)CH₃), 0.185 (s, 9H, Si(CH₃)₃). ³¹P-NMR (C₆D₆, 121 MHz): −21.1 (s).

### EXAMPLE A9 (REPLACEMENT OF BROMINE ATOM)

### Preparation of 1-[(dimethylamino)eth-1-yl]-2-(diphenylphosphino)-4-trimethylsilyl-5-formylferrocene (A9) of the Formula

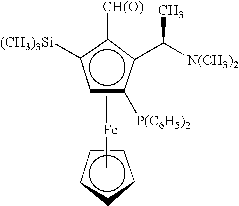

0.26 ml of n-Bu—Li (1.6M solution in hexane) is added dropwise to a solution of 226 mg (0.38 mmol) of A7 in 3 ml of TBME at 0° C. while stirring and the mixture is stirred at 0° C. for a further 1 hour. After addition of 38 microliters of DMF and after 15 minutes a further 0.5 ml of DMF, the mixture is stirred overnight at room temperature. The reaction mixture is extracted with water/TBME, the organic phases are dried over sodium sulfate and the solvent is distilled off under reduced pressure on a rotary evaporator. Purification is effected by chromatography (silica gel 60; eluent=heptane/TBME 4:1). ¹H-NMR (C₆D₆, 300 MHz), characteristic signals: 10.67 (s, 1H, CHO), 7.66-7.60 (m, 2H), 7.36-7.32 (m, 2H), 7.1-6.98 (m, 6H), 4.03 (m, 1H), 3.94 (s, 5H, cp), 3.73 (m, 1H), 1.80 (s, 6H, N(CH₃)₂), 1.55 (d, 3H, C(NMe₂)CH₃), 0.43 (s, 9H, Si(CH₃)₃). ³¹P-NMR (C₆D₆, 121 MHz): −23.6 (s).

### EXAMPLE A10

### Preparation of 1-[(dimethylamino)eth-1-yl]-2-bromo-3-(diphenylphosphino)-ferrocene (A10) of the Formula

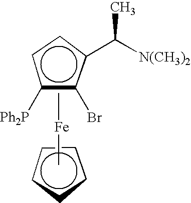

The procedure of Example A5 is repeated using diphenylphosphine chloride in place of dicyclohexylphosphine chloride. The crude product is purified by chromatography (silica gel 60; eluent=ethyl acetate containing 2% of triethylamine. The title compound is obtained as an orange solid in a yield of 73%. ¹H-NMR (C₆D₆, 300 MHz), characteristic signals: 7.62 (m, 2H), 7.65 (m, 2H), 7.11-6.99 (m, 6H), 4.03 (s, 5H), 3.96 (m, 1H), 3.90 (q, 1H), 3.65 (m, 1H), 2.19 (s, 6H), 1.31 (d, 3H). ³¹P-NMR (C₆D₆, 121 MHz): −18.4 (s).

### EXAMPLE A11 (REPLACEMENT OF BROMINE ATOM)

### 1-[(Dimethylamino)eth-1-yl]-2-carboxyl-3-(diphenylphosphino)ferrocene (A11) of the Formula

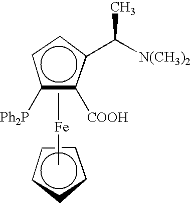

1.44 ml (2.31 mmol) of n-Bu—Li (1.6M solution in hexane) are added dropwise to a solution of 1.0 g (1.92 mmol) of A10 in 30 ml of TBME at −20° C. while stirring and the reaction mixture is stirred at this temperature for a further 2 hours. The reaction mixture is then cooled to −78° C. and transferred dropwise by means of a canula into a flask which has likewise been cooled to −78° C. and contains a magnetic stirrer bar and about 1 g of dry ice. After the transfer is complete, the cooling is removed and the mixture is stirred overnight. The mixture is worked up by addition of water, adjustment of the pH to 7-8 by addition of saturated NaHCO₃ solution and extraction, firstly with ethyl acetate and subsequently with methylene chloride. The organic phases are combined, dried over sodium sulfate and evaporated to dryness on a rotary evaporator. Purification by chromatography (silica gel 60; eluent=firstly methylene chloride/methanol 10:1, then 1:1) gives the title compound A11 as a brown material in a yield of 57%. ¹H-NMR (CD₃OD, 300 MHz), characteristic signals: 7.43-7.12 (various m, 10 aromatic H), 4.90 (q, 1H), 4.51 (m, 1H), 4.26 (s, 5H), 3.55 (m, 1H), 1.58 (d, 3H). ³¹P-NMR (CD₃OD, 121 MHz): −17.2 (s).

### EXAMPLE A12 (REPLACEMENT OF BROMINE ATOM)

### 1-[(Dimethylamino)eth-1-yl]-2-formyl-3-(diphenylphosphino)ferrocene (A12) of the Formula

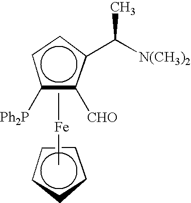

2.8 ml (4.6 mmol) of n-Bu—Li (1.6M solution in hexane) are added dropwise to a solution of 2.0 g (3.84 mmol) of A10 in 30 ml of TBME at 0° C. while stirring and the reaction mixture is stirred at this temperature for a further one hour. 0.63 ml (0.76 mmol) of dimethylformamide (DMF) is then slowly added dropwise over a period of 30 minutes. The mixture is stirred further at 0° C. for about 30 minutes, the cooling bath is then removed and the mixture is allowed to warm to room temperature. The reaction mixture is admixed with 20 ml of water and extracted with ethyl acetate. The organic phases are combined, washed with saturated aqueous NaCl, dried over sodium sulfate and evaporated to dryness on a rotary evaporator. Purification by chromatography (silica gel 60; eluent=EA/heptane 1:1 containing 1% of triethylamine) gives the title compound A12 as a red-orange foam in a yield of >95%. ¹H-NMR (C₆D₆, 300 MHz), characteristic signals: 10.47 (d, 1H), 7.60-6.98 (various m, 10 aromatic H), 4.24 (q, 1H), 4.15 (m, 1H), 3.94 (s, 5H), 3.82 (m, 1H), 2.09 (s, 6H), 1.18 (d, 3H). ³¹P-NMR (C₆D₆, 121 MHz): −19.1 (s).

### EXAMPLE A13 (REPLACEMENT OF BROMINE ATOM)

### 1-[(Dimethylamino)eth-1-yl]-2-hydroxymethyl-3-(diphenylphosphino)ferrocene (A13) of the Formula

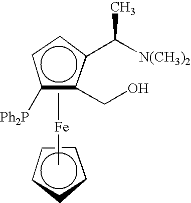

The procedure of Example A12 is repeated using paraformaldehyde as reactant instead of DMF. Purification by chromatography (silica gel 60; eluent=EA containing 1% of triethylamine) gives the title compound as an orange solid. ¹H-NMR (C₆D₆, 300 MHz), characteristic signals: 7.72-6.98 (various m, 10 aromatic H), 4.91 (m, 2H), 3.99 (m, 1H), 3.84 (q, 1H), 3.81 (s, 5H), 3.70 (m, 1H), 1.92 (s, 6H), 0.90 (d, 3H). ³¹P-NMR (C₆D₆, 121 MHz): −19.9 (s).

### EXAMPLE A14

### 1-[(Dimethylamino)eth-1-yl]-2-bromo-3-(di-ortho-anisylphosphino)ferrocene (A14) of the Formula

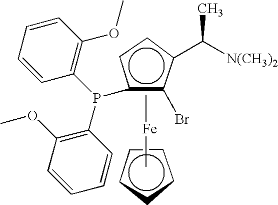

The procedure of Example A5 is repeated using di-orthb-anisylphosphine chloride, in place of dicyclohexylphosphine chloride. The crude product is purified firstly by chromatography (silica gel 60; eluent=toluene containing 1% of triethylamine) and subsequently by recrystallization from methanol(MeOH). This gives the title compound as a yellow solid in a yield of 64%. ¹H-NMR (C₆D₆, 300 MHz), characteristic signals: 7.36-6.36 (various m, 8 arom. H), 4.17 (s, 5H, cp), 4.02 (m, 1H), 3.95 (m, 1H), 3.47 (s, 3H), 3.11 (s, 3H), 2.24 (s, 6H, N(CH₃)₂), 1.37 (d, 3H). ³¹P-NMR (C₆D₆; 121 MHz): −44.2 (s).

### EXAMPLE A15 (REPLACEMENT OF BROMINE ATOM)

### 1-[(Dimethylamino)eth-1-yl]-2-(benzyl-1-hydroxy)-3-(di-ortho-anisylphosphino)ferrocene (A15) of the Formula

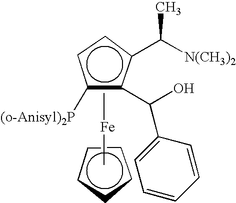

The procedure of Example A112 is repeated with the reaction being carried out at −70° C. using benzaldehyde instead of DMF. Purification by chromatography (silica gel 60; eluent=firstly heptane/EA 1:1 containing 2% of triethylamine, then ethyl acetate containing 2% of triethylamine) gives the title compound as a mixture of 2 diastereomers in a yield of 62%.

### Diastereomer 1 (Main Product):

¹H-NMR (C₆D₆, 300 MHz), characteristic signals: 3.64 (s, 5H, cp), 3.53 (s, 3H, O—CH₃), 3.14 (s, 3H, O—CH₃), 2.06 (s, 6H, N(CH₃)₂), 0.90 (d, 3H). ³¹P-NMR (C₆D₆, 121 MHz): −46.8 (s).

### Diastereomer 2:

¹H-NMR (C₆D₆, 300 MHz), characteristic signals: 4.13 (s, 5H, cp), 3.40 (s, 3H, O—CH₃), 3.06 (s, 3H, O—CH₃), 1.96 (s, 6H, N(CH₃)₂), 1.01 (d, 3H). ³¹P-NMR (C₆D₆, 121 MHz): −48.0 (s).

### EXAMPLE A16

### 1-Vinyl-2-bromo-3-(diphenylphosphino)ferrocene (A16) of the Formula

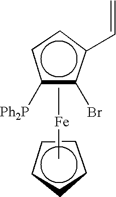

### a) Preparation of 1-vinyl-2-bromoferrocene (V3) of the Formula

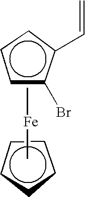

5.21 g (15.5 mmol) of the compound V1 in 30 ml of acetic anhydride are heated at 135° C. for 4 hours while stirring. After cooling, the mixture is extracted with water/toluene. The organic phases are collected, dried over sodium sulfate and the solvents are distilled off completely under reduced pressure (20 torr) on a rotary evaporator. The crude product is purified by chromatography if necessary (silica gel 60, eluent=heptane). This gives the compound V3 as a red-brown oil in a yield of 80%. ¹H-NMR (C₆D₆, 300 MHz) characteristic signals: δ 6.89 (m, 1H), 5.38 (m, 1H), 5.08 (m, 1H), 4.28 (m, 1H), 4.16 (m, 1H), 3.94 (s, 5H), 3.80 (m, 1H).

### b) Preparation of Compound A16

1.75 ml (10.3 mmol) of 2,2,6,6-tetramethylpiperidine are dissolved in 10 ml of absolute THF and cooled to 0° C. 6.4 ml (10.3 mmol) of n-Bu—Li solution (1.6M in hexane) are added dropwise. The mixture is then stirred at 0° C. for one hour (solution A). 1 g (3.4 mmol) of compound V3 are dissolved in 30 ml of absolute THF and cooled to −60° C. (solution B). Solution A is then added dropwise to solution B over a period of 15 minutes and the mixture is stirred for 1.5 hours, with the temperature being maintained at −40° C. The reaction mixture is cooled to −78° C. and 0.82 ml (4.4 mmol) of diphenylphosphine chloride is added. After stirring at −78° C. for a further 2.5 hours, the reaction mixture is admixed with a little water at about −40° C. and extracted with saturated, aqueous ammonium chloride solution and TBME. The combined organic phases are dried over sodium sulfate and freed of the solvent on a rotary evaporator. The crude product is purified by chromatography (silica gel 60; eluent=ethyl acetate/heptane 1:20). This gives the title compound as a brown solid in a yield of 90%.

¹H-NMR C₆D₆, 300 MHz), characteristic signals: 7.60-6.98 (various m, 8 aromatic H), 6.74 (m, 1H), 5.41 (m, 1H), 5.08 (m, 1H), 4.35 (m, 1H), 3.98 (s, 5H), 3.72 (m, 1H). ³¹P-NMR (C₆D₆, 121 MHz): −18.6.

### EXAMPLE A17 (REPLACEMENT OF BROMINE ATOMS)

### 1-Vinyl-2-trimethylsilyl-3-(diphenylphosphino)ferrocene (A17) of the Formula

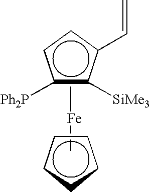

0.4 ml (0.65 mmol) of n-Bu—Li (1.6M solution in hexane) is added dropwise to a solution of 250 mg (0.51 mmol) of V3 in 10 ml of TBME at −60° C. while stirring. The reaction mixture is stirred for a further one hour and the temperature is allowed to rise to 0° C. during this time. After stirring at 0° C. for a further 45 minutes, the mixture is cooled to −78° C. and 102 mg of trimethylchlorosilane are slowly added dropwise. The cooling bath is removed, the mixture is allowed to warm to room temperature and stirred overnight. The reaction mixture is admixed with 5 ml of saturated aqueous NaHCO₃ solution and extracted with ethyl acetate. The organic phases are combined, washed with water, dried over sodium sulfate and evaporated to dryness on a rotary evaporator. Purification by chromatography (silica gel 60; eluent=ethyl acetate/heptane 1:20) gives the title compound A17 as a red-orange foam in a yield of 82%. ¹H-NMR (C₆D₆, 300 MHz), characteristic signals: 7.56-6.97 (various m, 10 aromatic H), 6.85 (m, 1H), 5.36 (m, 1H), 5.02 (m, 1H), 4.65 (m, 1H), 3.98 (s, 5H), 0.45 (m, 9H). ³¹P-NMR (C₆D₆, 121 MHz): −16.8.

### EXAMPLE A18

### 1-Ethyl-2-bromo-3-(diphenylphosphino)ferrocene (A18) of the Formula

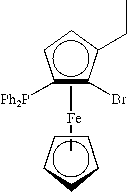

### a) Preparation of 1-ethyl-2-bromoferrocene (V4) of the Formula

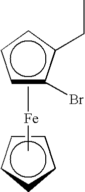

A solution of 7.1 g (24.4 mmol) of the compound V3 in 35 ml of THF is stirred vigorously in the presence of 0.7 g of catalyst (5% Rₕ/C, Engelhard) in a hydrogen atmosphere (atmospheric pressure) until no more hydrogen is consumed. The reaction mixture is then placed under argon and the catalyst is filtered off. After washing with a little THF, the filtrate is freed completely of the solvent in a rotary evaporator. The compound V4 is obtained in quantitative yield as an orange oil. ¹H-NMR (C₆D₆, 300 MHz) characteristic signals: δ 4.24 (m, 1H), 3.96 (s, 5H), 3.77 (m, 1H), 3.71 (m, 1H), 2.42-2.23 (m, 2H), 1.05 (t, 3H).

### b) Preparation of Compound A18

The compound A18 is prepared by a method similar to Example A16b. After lithiation of the compound V4 by means of Li-TMP, the lithiated compound is reacted with diphenylphosphine chloride. Purification by chromatography (silica gel 60; eluent heptane/EA 20:1) gives the title compound as a brown solid (yield 59%). ¹H-NMR (C₆D₆, 300 MHz) characteristic signals: δ 7.62 (m, 2H), 7.38 (m, 2H), 7.1-6.9 (m, 6H), 3.99 (s, 5H), 3.94 (m, 1H), 3.59 (m, 1H), 2.47-2.26 (m, 2H), 1.07 (t, 3H). ³¹P-NMR (C₆D₆, 121 M Hz): δ-18.2 (s).

### EXAMPLE A19

### Preparation of 1-diethylamino-2-bromo-3-trimethylsilylferrocene (A19) of the Formula

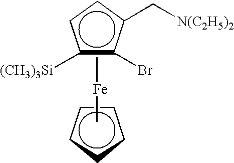

### a) Preparation of 1-(α-methoxymethylpyrrolinin-N-yl)methyl-2-bromoferrocene V5 of the Formula

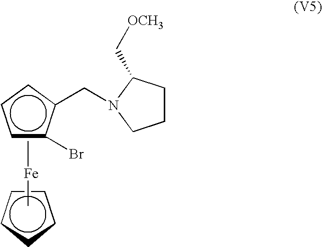

13 ml (20.8 mmol) of n-Bu—Li (1.6M solution in hexane) are added dropwise to a solution of 5 g (16 mmol) of (α-methoxymethylpyrrolinin-N-yl)methylferrocene (see L. Xiao et al., Synthesis, 8 (1999) 1354-1362) in 100 ml of TBME at 0° C. while stirring. The mixture is stirred at 0° C. for a further 3 hours. It is then cooled to −78° C. and 5.2 g (20 mmol) of 1,2-dibromotetrafluoroethane are added. The cooling bath is removed and the temperature is allowed to rise slowly to room temperature. The reaction mixture is admixed with 50 ml of water and extracted with EA. The organic phases are combined, washed with water, dried over sodium sulfate and evaporated to dryness on a rotary evaporator. Purification by chromatography (silica gel 60; eluent=EA/heptane 1:5) gives the orange compound V5 in a yield of 80%. ¹H-NMR (C₆D₆, 300 MHz) characteristic signals: δ 4.38 (m, 1H), 4.18 (m, 1H), 4.11 (s, 5H), 3.34 (s, 3H).

### b) Preparation of 1-diethylaminomethyl-2-bromoferrocene (V6) of the Formula

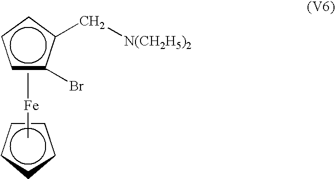

0.26 ml (4 mmol) of methyl iodide is added to a solution of 532 mg (1.36 mmol) of compound V5 in 2 ml of acetonitrile. The reaction mixture is stirred at room temperature for 10 minutes and the solvent and the excess methyl iodide are then distilled off under reduced pressure. The residue is redissolved in 7 ml of acetonitrile and stirred together with 0.3 ml (2.7 mmol) of diethylamine overnight at 100° C. in a pressure ampoule. After cooling, the reaction mixture is evaporated to dryness on a rotary evaporator. The crude product is purified by chromatography (silica gel 60; eluent=EA containing 0.2% of triethylamine). The compound V6 is isolated as a red-brown oil in a yield of 90%.

¹H-NMR (C₆D₆, 300 MHz), characteristic signals: δ 4.25 (m, 1H), 4.09 (m, 1H), 3.96 (s, 5H), 3.75 (m, 1H), 3.74-3.46 (m, 2H), 2.54-3.46 (m, 4H), 1.02 (t, 6H).

### c) Preparation of the Title Compound A19

0.19 ml (1.1 mmol) of 2,2,6,6-tetramethylpiperidine are dissolved in 1.5 ml of absolute THF and cooled to 0° C. 0.64 ml (1.0 mmol) of n-Bu—Li solution (1.6M in hexane) is added dropwise. The mixture is subsequently stirred at 0° C. for one hour (solution A). 128 mg (0.36 mmol) of compound V6 are dissolved in 0.5 ml of absolute THF and cooled to −60° C. (solution B). Solution A is then added dropwise to solution B over a period of 15 minutes and the mixture is stirred for 1.5 hours, with the temperature being maintained at −40° C. The reaction mixture is cooled to −78° C. and 0.14 ml (1.1 mmol) of chlorotrimethylsilane is added. After stirring at −78° C. for a further 0.5 hour, the reaction mixture is admixed with a little water at about −40° C. and extracted with TBME. The combined organic phases are dried over sodium sulfate and freed of the solvent on a rotary evaporator. The crude product is purified by chromatography (silica gel 60; eluent=TBME). This gives the orange title compound A19 in a yield of 75%.

¹H-NMR (C₆D₆, 300 MHz), characteristic signals: δ 4.29 (m, 1H), 4.00 (s, 5H), 3.86 (m, 1H), 3.70-3.50 (m, 2H), 2.50 (m, 4H), 1.01 (t, 6H), 0.36 (s, 9H).

### EXAMPLE A20 (REPLACEMENT OF BROMINE ATOM)

### Preparation of 1-diethylamino-2-diphenylphosphino-3-trimethylsilylferrocene (A20) of the Formula

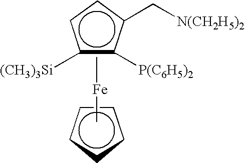

0.21 ml (0.33 mmol) of n-Bu—Li (1.6M solution in hexane) is added dropwise to a solution of 120 mg (0.29 mmol) of the compound A19 in 2 ml of TBME at 0° C. while stirring and the reaction mixture is then stirred at this temperature for a further one hour. 0.067 ml (0.36 mmol) of diphenylphosphine chloride is then slowly added dropwise. The mixture is stirred further at 0° C. for about 30 minutes, the cooling bath is then removed and the mixture is allowed to warm to room temperature. The reaction mixture is admixed with 5 ml of water and extracted with TBME. The organic phases are combined, washed with saturated aqueous NaCl, dried over sodium sulfate and evaporated to dryness on a rotary evaporator. Purification by chromatography (silica gel 60; eluent=TBME) gives the title compound A20 as a red-orange foam in a yield of 75%. ¹H-NMR (C₆D₆, 300 MHz), characteristic signals: δ 7.77 (m, 2H), 7.33 (m, 2H), 7.13-7.00 (m, 6H), 4.72 (m, 1H), 4.25 (m, 1H), 4.12 (s, 5H), 2.93-2.73 (m, 2H), 2.45-2.22(m, 4H), 0.83 (t, 3H), 0.40 (m, 9H). ³¹P-NMR (C₆D₆, 121 MHz): δ-12.8 (s).

### EXAMPLE A21

### Preparation of 1-diethylamino-2-bromo-3-methylferrocene (A21) of the Formula

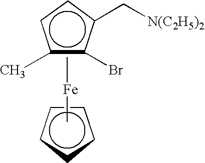

Proceeding in a manner similar to Example A19c and using methyl iodide in place of chlorotrimethylsilane gives the title compound A21.

### EXAMPLE A22 (REPLACEMENT OF BROMINE ATOM)

### Preparation of 1-diethylamino-2-diphenylphosphino-3-methylferrocene (A22) of the Formula

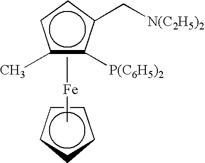

Proceeding in a manner similar to Example A20 and using the compound A21 in place of the compound A19 gives the title compound A22.

1. A compound of the formula I or II in the form of an enantiomerically pure diastereomer or a mixture of diastereomers, 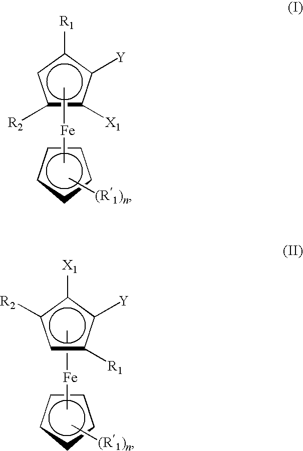
where
R′₁ is C₁-C₄-alkyl or phenyl and n is 0 or an integer from 1 to 5;
R₁ is a hydrogen atom, a hydrocarbon radical having from 1 to 20 carbon atoms, sec-phosphino, a mercaptan radical having from 1 to 20 carbon atoms in the hydrocarbon radical or a silyl radical having 3 C₁-C₁₂-hydrocarbon radicals;
R₂ is the monovalent radical of an electrophilic organic compound;
X₁ is F, Cl, Br or I;
Y is vinyl, methyl, ethyl, —CH₂—OR, —CH₂—N(C₁-C₄-alkyl)₂ or a C-, S- or P-bonded chiral group which directs metals of metallating reagents into the ortho position X₁; and
R is an aliphatic, cycloaliphatic, aromatic or aromatic-aliphatic hydrocarbon radical which has from 1 to 18 carbon atoms and is unsubstituted or substituted by C₁-C₄-alkyl, C₁-C₄-alkoxy, F or CF₃.

2. The compound as claimed in claim 1, characterized in that a hydrocarbon radical R₁ contains from 1 to 12 carbon atoms.

3. The compound as claimed in claim 2, characterized in that R₁ is H or C₁-C₄-alkyl.

4. The compound as claimed in claim 1, characterized in that the hydrocarbon radical in mercaptan radical R₁ preferably contains from 1 to 12 carbon atoms.

5. The compound as claimed, in claim 1, characterized in that a silyl radical R₁ corresponds to the formula R₀₁R₀₂R₀₃Si—, where R₀₁, R₀₂ and R₀₃ are each, independently of one another, C₁-C₁₂-alkyl, unsubstituted or C₁-C₄-alkyl- or C₁-C₄-alkoxy-substituted C₆-C₁₀-aryl or C₇-C₁₂-aralkyl.

6. The compound as claimed in claim 1, characterized in that a secondary phosphino group R₁ contains two identical or different hydrocarbon radicals which have from 1 to 22 carbon atoms, are unsubstituted or substituted and/or contain heteroatoms selected from the group consisting of O, S, —N═ or N(C₁-C₄-alkyl).

7. The compound as claimed in claim 6, characterized in that the secondary phosphino group contains two identical or different radicals selected from the group consisting of linear or branched C₁-C₁₂-alkyl; unsubstituted or C₁-C₆-alkyl- or C₁-C₆-alkoxy-substituted C₅-C₁₂-cycloalkyl or C₅-C₁₂-cycloalkyl-CH₂—; phenyl, naphthyl, furyl or benzyl; and C₁-C₆-alkyl-, trifluoromethyl-, C₁-C₆-alkoxy-, trifluoromethoxy-, (C₆H₅)₃Si—, (C₁-C₁₂-alkyl)₃Si— or sec-amino-substituted phenyl or benzyl.

8. The compound as claimed in claim 1, characterized in that a secondary phosphino group R₁ is cyclic secondary phosphino having one of the formulae 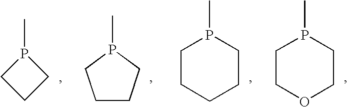
which are unsubstituted or substituted by one or more C₁-C₈-alkyl, C₄-C₈-Cycloalkyl, C₁-C₆-alkoxy, C₁-C₄-alkoxy-C₁-C₄-alkyl, phenyl, C₁-C₄-alkylphenyl or C₁-C₄-alkoxyphenyl, benzyl, C₁-C₄-alkylbenzyl or C₁-C₄-alkoxybenzyl, benzyloxy, C₁-C₄-alkylbenzyloxy or C₁-C₄-alkoxybenzyloxy or C₁-C₄-alkylidenedioxyl radicals.

9. The compound as claimed in claim 1, characterized in that X₁ is Br.

10. The compound as claimed in claim 1, characterized in that the radical R₂ is halide, —C(O)OH, —C(O)—OR, —C(O)—R, —CH═O, —CH(OH)—R, —CH₂OH, C₁-C₁₈-alkyl, (C₁-C₈-alkyl)₃Si—, sec-phosphino and RS—, where R is alkyl, cycloalkyl, cycloalkylalkyl, aryl, aralkyl, heteroaryl, heteroaralkyl having from 1 to 12 carbon atoms.

11. The compound as claimed in claim 10, characterized in that R₂ is F, —Cl, —Br, C₁-C₄-alkyl, phenyl, benzyl, (C₁-C₄-alkyl)₃Si—, RS—, where R is C₁-C₄-alkyl or phenyl, or sec-phosphino.

12. The compound as claimed in claim 1, characterized in that in the ortho-directing, chiral group Y, the chiral atom is bound in the 1, 2 or 3 position relative to the cyclopentadienyl-Y bond.

13. The compound as claimed in claim 1, characterized in that the group Y is an open-chain radical having a total of from 1 to 20 atoms or a cyclic radical having 4 or 7 ring atoms and a total of from 4 to 20 and preferably from 4 to 16 atoms, with the atoms being selected from the group consisting of C, O, S, N and P and carbon atoms being saturated with hydrogen.

14. The compound as claimed in claim 13, characterized in that the group Y corresponds to the formula —HC*R₅R₆ (* denotes a chiral carbon atom), where R₅ is C₁-C₈-alkyl, C₅-C₈-cycloalkyl, phenyl or benzyl, R₆ is —OR₇ or —NR₈R₉, R₇ is C₁-C₈-alkyl, C₅-C₈-cycloalkyl, phenyl or benzyl and R₈ and R₉ are identical or different and are each C₁-C₈-alkyl, C₅-C₈-cycloalkyl, phenyl or benzyl or R₈ and R₉ together with the N atom form a five- to eight-membered ring.

15. The compound as claimed in claim 1, characterized in that the group Y is 1-methoxyeth-1-yl, 1-dimethylaminoeth-1-yl or 1-(dimethylamino)-1-phenylmethyl.

16. The compound as claimed in claim 1, characterized in that Y is a radical which does not have a chiral α carbon atom and is bound to the cyclopentadienyl ring via a carbon atom either directly or via a bridging group, preferably methylene, ethylene or an imine group.

17. The compound as claimed in claim 16, characterized in that cyclic radicals selected from among C₁-C₄-alkyl-, (C₁-C₄-alkyl)₂NCH₂—, (C₁-C₄-alkyl)₂NCH₂CH₂—, C₁-C₄-alkoxymethyl- or C₁-C₄-alkoxyethyl-substituted N—, O— or N,O-heterocycloalkyl having a total of 5 or 6 ring atoms are bound to the bridging group or Y is an open-chain radical which is preferably bound to the cyclopentadienyl ring via a CH₂ group and is derived from an amino acid or ephedrine.

18. The compound as claimed in claim 1, characterized in that Y is a radical having one of the formulae 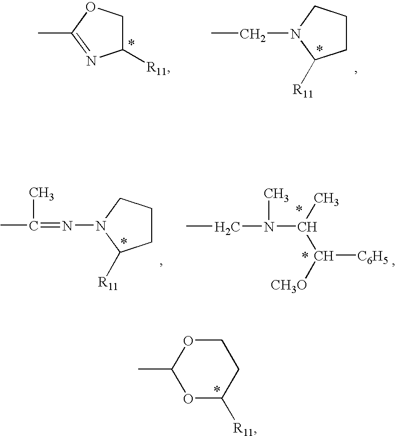
where R₁₁ is C₁-C₄-alkyl, phenyl, (C₁-C₄-alkyl)₂NCH₂—, (C₁-C₄-alkyl)₂NCH₂CH₂—, C₁-C₄-alkoxymethyl or C₁-C₄-alkoxyethyl.

19. The compound as claimed in claim 1, characterized in that P-bonded chiral groups Y are unprotected or BH₃-protected diaminophosphino in which N-heterocycloalkyl which has a total of 4, 5, 6 or 7 ring atoms and is substituted by C₁-C₄-alkyl, C₁-C₄-alkoxymethyl or C₁-C₄-alkoxyethyl in the α position relative to the N atom or a 1,2-diamino-C₄-C₇-cycloalkyl radical is bound to the phosphorus atom or in which an N,N′-substituted diamine is bound to the phosphorus atom so as to form, together with the P atom, an N,P,N-heterocycloaliphatic ring having from 4 to 7 ring atoms.

20. The compound as claimed in claim 1, characterized in that Y corresponds to one of the formulae 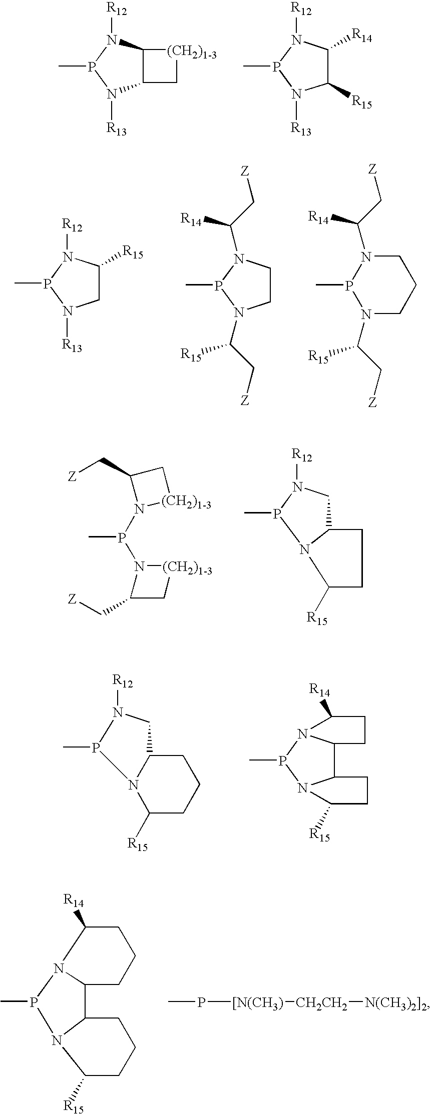
where
R₁₂ and R₁₃ are identical or different, preferably identical, and are each C₁-C₄-alkyl, C₁-C₄-alkoxyethyl, (C₁-C₄-alkyl)₂N-ethyl,
R₁₄ and R₁₅ are identical or different, preferably identical, and are each H, C₁-C₄-alkyl, phenyl or methylphenyl and
Z is H, C₁-C₄-alkyl, C₁-C₄-alkoxy, C₁-C₄-alkylthio, —N(C₁-C₄-alkyl)₂, phenyl, phenoxy, methoxyphenyl or methoxyphenoxy. Some further examples of Z are methyl, ethyl, methoxy, ethoxy, methylthio and dimethylamino.

21. A process for preparing compounds of the formulae I and II, as claimed in claim 1 which comprises the steps:
a) reaction of a compound of the formula III 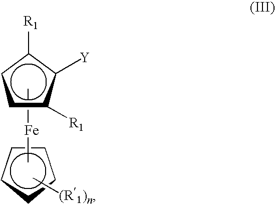
where
(a1) R′₁, n and R₁ are as defined above and one of the radicals R₁ is a hydrogen atom, Y is as defined above with the exception of Y=vinyl, methyl, ethyl or
(a2) R′₁, n and R₁ are as defined above and both radicals R₁ are hydrogen atoms and Y is a C-, S- or P-bonded chiral group which directs metals of metallizing reagents into the ortho position X₁,
firstly with at least equivalent amounts of an alkyllithium or a magnesium Grignard compound and then with at least equivalent amounts of a halogenating reagent to form a compound of the formula IV or V, 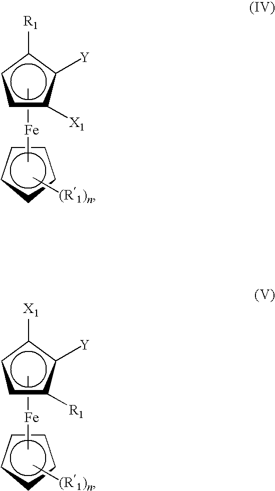
where X₁ is F, Cl, Br or I,
b) reaction of a compound of the formula IV or V or a compound of the formula IV or V in which Y is vinyl, methyl, ethyl with at least equivalent amounts of an aliphatic lithium sec-amide or a halomagnesium sec-amide to form compounds of the formula VI or VII, 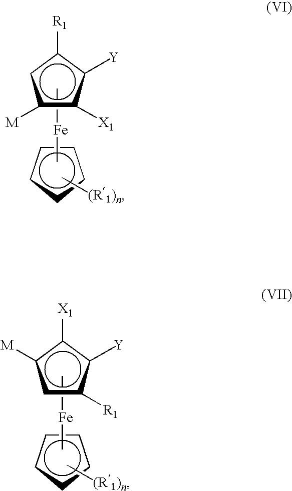
where M is Li or —MgX₂ and X₂ is Cl, Br or I,
c) reaction of a compound of the formula VI or VII with an electrophilic organic compound to introduce the monovalent radical R₂ and form the compounds of the formula I or II.

22. The process as claimed in claim 21, characterized in that the aliphatic lithium sec-amide or X₂Mg sec-amide is derived from a secondary amine containing from 2 to 18 carbon atoms.

23. The process as claimed in claim 22, characterized in that the aliphatic radicals bound to the N atom of the secondary amine are each alkyl, cycloalkyl or cycloalkylalkyl or the secondary amine is an N-heterocyclic ring having from 4 to 12 carbon atoms.

24. The process as claimed in claim 22, characterized in that the amide corresponds to the formula Li—N(C₃-C₄-alkyl)₂ or X₂Mg—N(C₃-C₄-alkyl)₂.

25. The process as claimed in claim 23, characterized in that the amide is Li—N(i-propyl)₂ or Li(2,2,6,6-tetramethylpiperidine).
